(19) United States
(12) Patent Application Publication
(10) Pub. No.: US 2021/0146807 A1
(43) Pub. Date: May 20, 2021

(54) Autonomous automobile

(71) Applicant: Donald Layton Wood, Walled Lake, MI (US)

(72) Inventor: Donald Layton Wood, Walled Lake, MI (US)

(21) Appl. No.: 16/602,669

(22) Filed: Nov. 19, 2019

(51) Int. Cl. B60N 2/20; B62D 25/20; B60K 1/04; B60N 2/01; B60J 5/10

(52) U.S. Cl. CPC B60N 2/206; B62D 25/20; B60K 1/04; G05D 1/0088; B60J 5/101; B60K 2001/0438; B60N 2/01

(57) ABSTRACT

A vehicle including power means configured to allow the entire upper surface of the floor structure to be available for the seating and cargo means. The seating and cargo means includes a first rearwardly facing seat assembly and a second confronting forwardly facing seat assembly. The seatback portions are pivotal downwardly into overlying relation to the cushion portions and into horizontal alignment with first and second cargo surfaces defined by the upper face of the floor structure between the front of the vehicle and the first seat assembly, and between the rear of the vehicle and the second seat assembly. The cushion portions of the seat assemblies are longitudinally spaced and the seatback portions have a height sufficient to fill the space to form a continuous cargo surface extending from the front of the vehicle to the rear of the vehicle. Gates in the front and rear ends of the vehicle allow front and rear access to the cargo surface.

This application is entitled to the filing date of an earlier filed Provisional Patent Application Ser. No. 62/917,686 filed on December 26th of 2018.

### BACKGROUND OF THE INVENTION

U.S. automobiles over the years have had many forms. Early land automobiles were powered by various devices including steam, electric, and gasoline. When Cadillac was awarded the Dewar Trophy in 1912 for their improvements relating to self-starters the tide suddenly turned to gasoline powered automobiles. This continued until the mid-1960s when the electric automobile reemerged and gradually gained in popularity. The autonomous automobile emerged in the 1980s. The autonomous automobile is inherently an electric automobile, and undoubtedly, the automobile of the future will be both electric and autonomous.

### SUMMARY OF THE INVENTION

The invention relates to an autonomous vehicle or automobile consisting of wheels to support the vehicle, a generally rectangular roof structure, a generally rectangular floor structure extending from the front end of the vehicle to the rear end of the vehicle and including areas proximate each corner of the floor structure to accommodate a respective wheel, a generally rectangular full height front structure defining the front end of the vehicle, a generally rectangular full height rear structure defining the rear end of the vehicle, a generally rectangular full height left side structure defining the left side of the vehicle, a generally rectangular full height right side and coacting with the roof, floor, front, rear, and left side structures to define an interior volume for the vehicle, means for guiding the vehicle to a predetermined location, seating, and cargo means for the vehicle, mapping means for guiding the vehicle to the predetermined location, and power means for propelling the vehicle.

According to an important feature of the invention, the power means in configured to allow substantially the entire upper face of the floor structure to be available for the seating and cargo means.

According to a further feature of the invention, the power means includes a means for generating electricity and an electric motor connected to the means for generating electricity.

According to a further feature of the invention, the power means includes a battery and an electric motor connected to the battery.

According to a further feature of the invention, the seating and cargo means includes a rearwardly facing seat assembly including a first seat cushion portion and a first upright seatback portion pivotally mounted on the first cushion portion for movement rearwardly and downwardly into overlying relation to the first cushion portion and into substantial horizontal alignment with a first cargo surface defined by the upper face of the floor structure between the front end of the vehicle and proximate the rearwardly facing seat assembly.

According to a further feature of the invention, the seating and cargo means includes confronting rearwardly facing and forwardly facing seat assemblies including longitudinally spaced cushion portions and upright seatback portions. One of the seat assemblies includes an upright seatback portion pivotally mounted on its cushion portion for the pivotal movement downwardly into overlying relation to its cushion portion and into substantial horizontal alignment with a cargo surface defined by the upper face of the floor structure between one end of the vehicle and proximate the one seat assembly.

According to a further feature of the invention, the one seat assembly comprises a first rearwardly facing seat assembly. The other second seat assembly comprises a forwardly facing seat assembly, both upright seatback portions are pivotally mounted on its cushion portion. In the first seat assembly the upright seatback portion moves rearwardly and downwardly into overlying relation to its cushion portion. In the second seat assembly the upright seatback portion moves forwardly and downwardly into overlying relation to its cushion portion. The cargo surface is a first cargo surface defined by the upper face of the floor structure between the front end of the vehicle and proximate the first seat assembly. The vehicle further includes a second cargo surface defined by the upper face of the floor structure between the rear end of the vehicle and proximate the second seat assembly. The upright seatback portion of the second seat assembly, when downwardly folded, moves into substantial horizontal alignment with the second cargo surface, and the vehicle further includes means, including the downwardly folded upright seatback portions to fill the longitudinal space between the cushion portions so as to form a substantially continuous cargo surface extending from the front end of the vehicle to the rear end of the vehicle.

According to a further feature of the invention, the upright seatback portions have a height sufficient to fill the longitudinal space between the cushion portions.

According to a further feature of the invention, the vehicle further includes a full height frontend structure attached to and extending upwardly from the front end of the floor structure and including a gate in the front end structure providing front end access to the substantially continuous cargo surface.

According to a further feature of the invention, the vehicle further includes a full height rear end structure attached to and extending upwardly from the rear end of the floor structure and including a gate in the rear end structure providing rear end access to the substantially continuous cargo surface.

These and other features of the invention will be apparent from the following detailed description of a preferred embodiment of the invention.

### BRIEF DESCRIPTION OF THE DRAWINGS

FIG. 1 is a partial rear perspective sectional view of the invention vehicle.

FIG. 2 is an under view of the invention vehicle.

FIG. 3 is a side view of the invention vehicle.

FIG. 4 is a perspective view of the invention vehicle with seating means removed.

FIG. 5 is a perspective view of the invention vehicle.

FIG. 6 is an overview of the invention vehicle with the seatbacks in an upright position.

FIG. 7 is an overview of the invention vehicle with the seatbacks in a downwardly folded position.

FIG. 8 is a sectional fragmentary perspective view of the invention vehicle.

FIG. 9 is a schematic perspective view of the invention vehicle.

FIG. 10 is a side view of FIG. 9.

FIG. 11 is a sectional side view of the invention vehicle.

FIG. 12 is a fragmentary sectional perspective view of the invention vehicle.

FIG. 13 is a front end view of the invention vehicle.

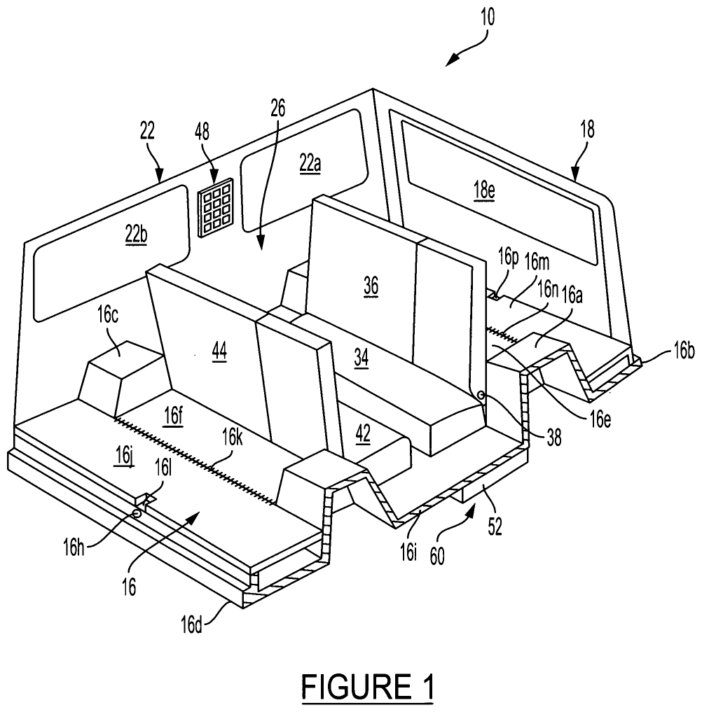

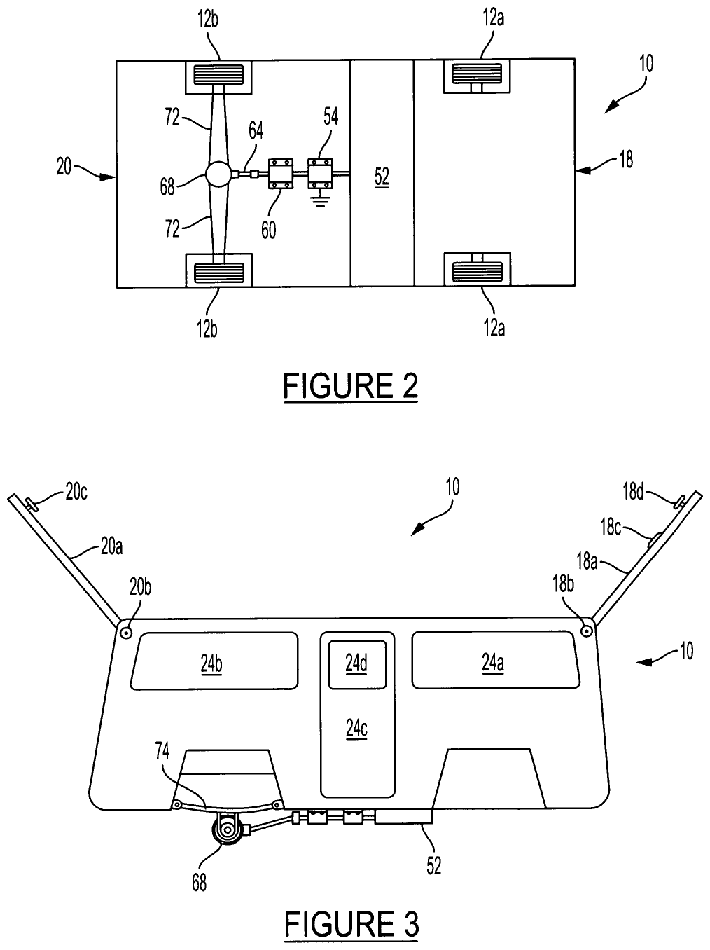

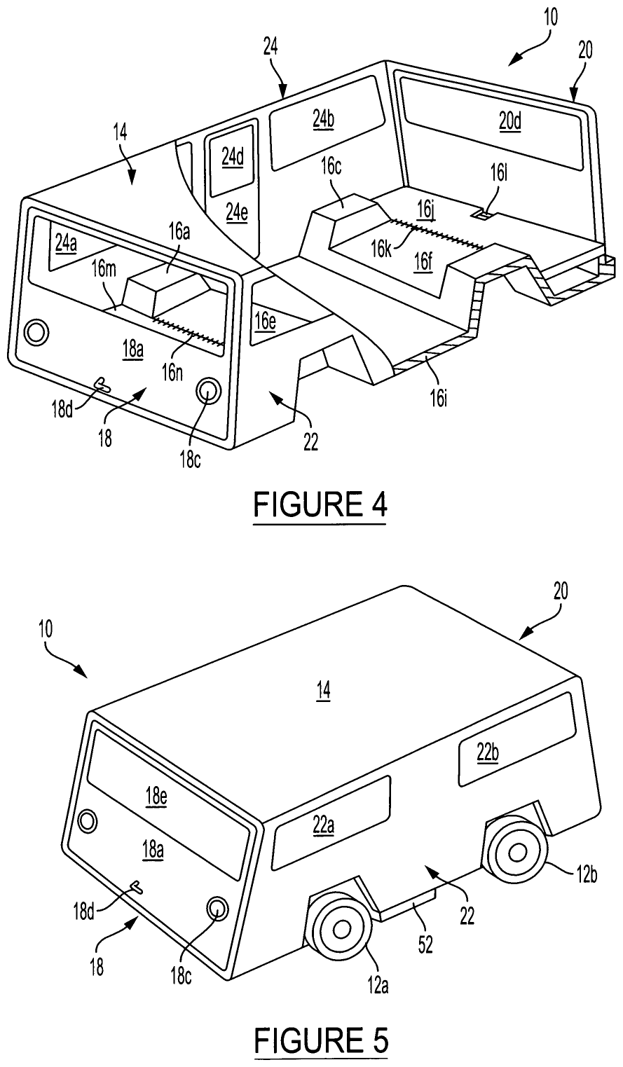

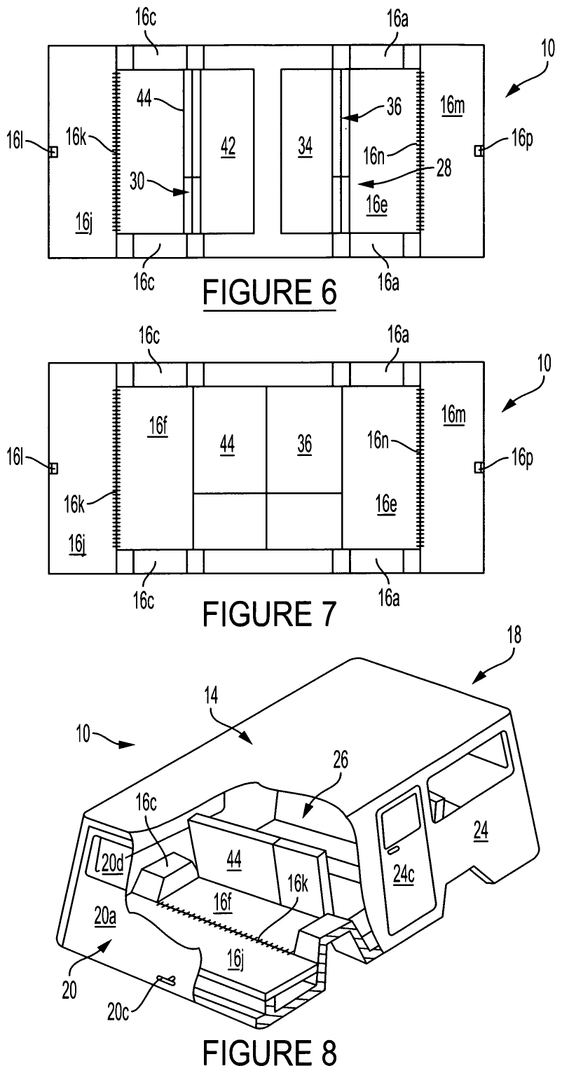

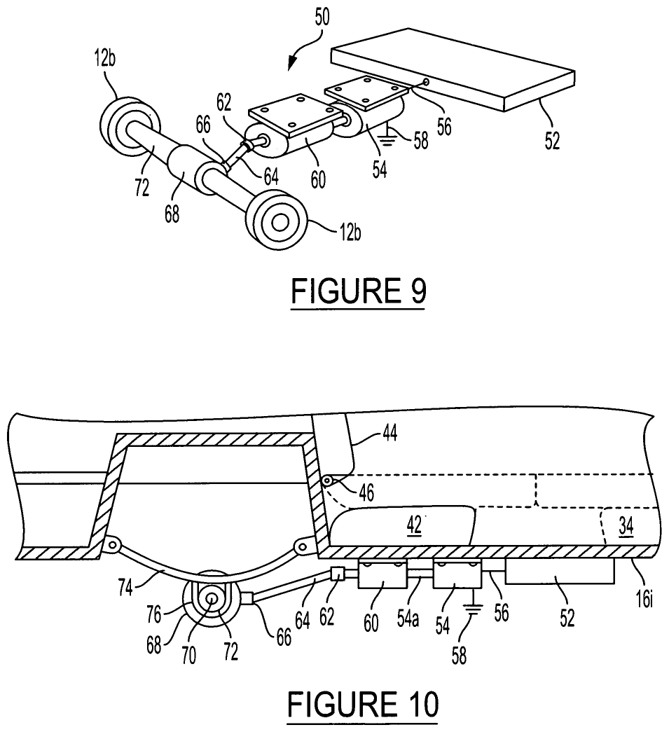

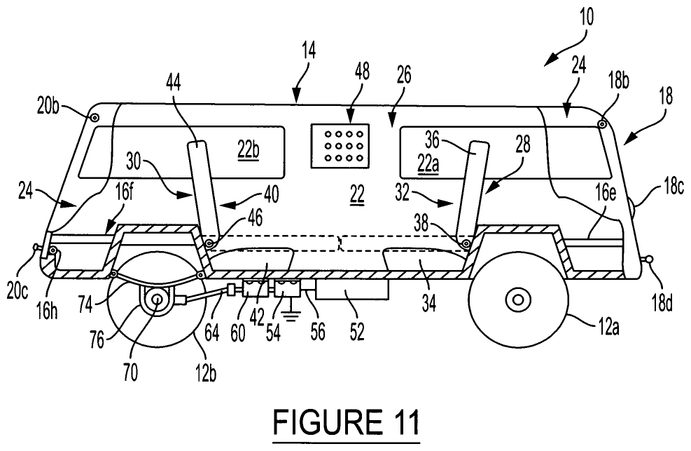

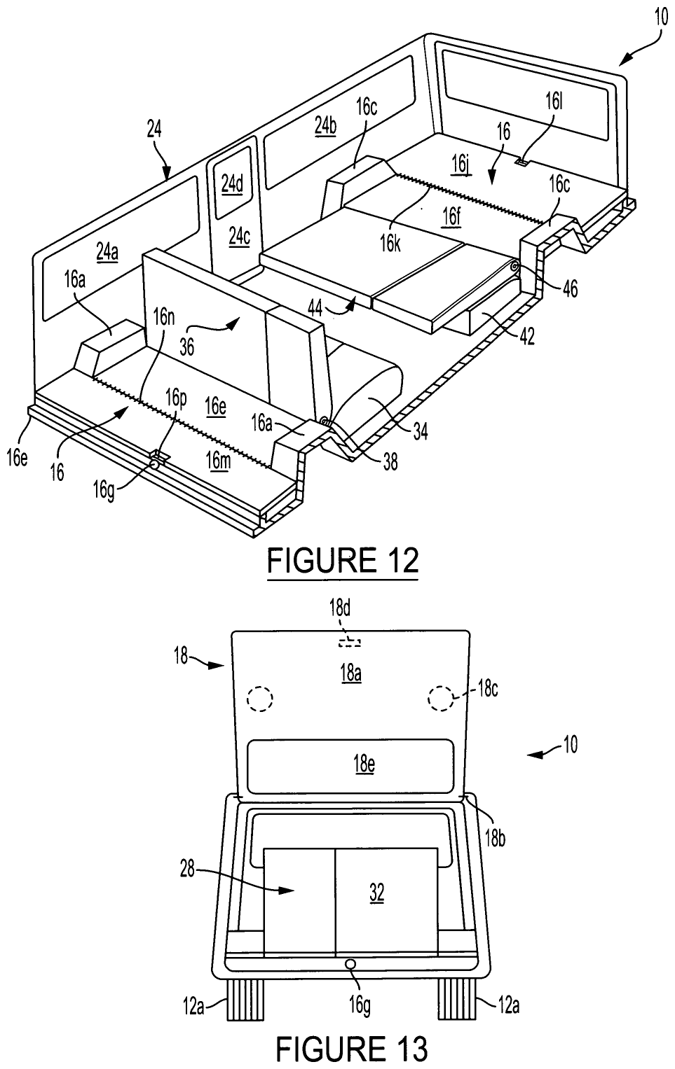

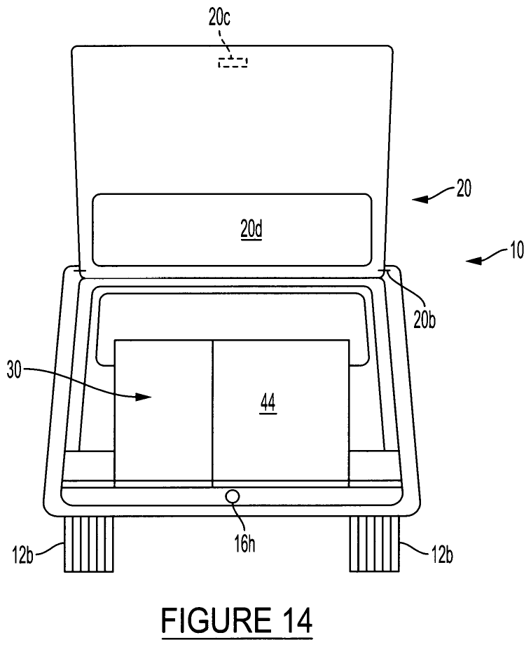

And FIG. 14 is a rear end view of the invention vehicle.

### DETAILED DESCRIPTION OF A PREFERRED EMBODIMENT

The vehicle or automobile shown in the drawings is of the autonomous type and includes features of all of the U.S. patents identified in the information disclosure statement, including the feature of a mapping means to guide the automobile to a predetermined location as demonstrated, inter alia, by the Chevrolet Tahoe entered by Tartan Racing of Carnegie Mellon University Navlab in the 2007 Grand Challenge Robot Race sponsored by DARPA, are incorporated herein by reference. It will be understood that the automobile illustrated in the drawings is autonomous and includes various sensors including cameras, radar, lidar, and a mapping device to enable the automobile to go to a predetermined location.

The automobile 10 of the invention includes a plurality of forward wheels 12a and rearward wheels 12b, a roof structure 14, a floor structure 16, a front end structure 18, a rear end structure 20, a left side structure 22, and a right side structure 24. Structures 14,16,18,20,22, and 24 coact to define an interior volume 26 for the vehicle.

Roof structure 14 has a generally rectangular horizontal configuration. Floor structure 16 has a generally rectangular horizontal configuration and extends from the front end of the vehicle to the rear end of the vehicle and further includes front raised portions 16a adjacent each front corner, 16b of the floor structure and rear raised portions, 16c adjacent each rear corner, 16d to accommodate a respective wheels 12a, 12b.

Floor structure 16 further includes a front panel structure 16e spaced above the general level of the floor structure and embracing raised portions 16a, a rear panel structure 16f spaced above the general level of the floor structure and embracing raised portions 16c, a front latching means 16g at the front end of the floor structure, and a rear latching means 16h at the rear end of the floor structure. Front end structure 18 has a generally rectangular vertical full height structure and is attached to and extends upwardly from the front end of the floor structure and includes an upwardly pivotal front gate 18a on pivot axis 18b. Front end structure 18 also includes headlights 18c, a handle 18d controlling latching means 16g, and a windshield 18e.

Rear end structure 20 has a generally rectangular vertical full height configuration and is attached to and extends upwardly from the rear end of the floor structure and includes an upwardly pivotal rear gate 20a pivoting on axis 20b and includes a handle 20c controlling latching means 16h, and a rear window 20d.

Left side structure 22 has a generally rectangular vertical full height configuration and includes spaced front and rear windows 22a, 22b.

Right side structure 24 has a generally rectangular vertical full height structure and includes spaced front and rear windows 24a, 24b, and a central door 24c, having a window 24d, providing ingress to interior volume 26.

The autonomous vehicle of the invention also defines a front seating and cargo means 28, and a rear seating and cargo means 30.

The front seating and cargo means 28 includes a rear facing seat assembly 32 positioned rearwardly of panel structure 16e and including a seat cushion portion 34 and an upright seatback portion 36. The upright seatback portion 36 is arranged by a pivot 38 to pivot rearwardly and downwardly into overlying relation to seat cushion portion 34. Upright seatback portion 36 may be split ⅓, ⅔ to accommodate various seating and cargo situations and the cushion portion 34 may, at each end, include a handle, not shown, and a spring, not shown, which is compressed in response to pivotal movement to the upright position and which spring is released in response to actuation of a respective handle.

The front seating and cargo means 2f also include the upper surface of the floor structure 16e which presents a cargo surface accessible by front gate 18 a and is contiguously substantially horizontally aligned with the upper surface of the rearwardly and downwardly pivoted upright seatback portion 36 so that the upper surface of forward floor structure 16e defines a smooth cargo surface with the upper surface of the rearwardly and downwardly pivoted upright seatback portion 36.

Rear seating and cargo means 30 includes a front facing seat assembly 40 positioned forwardly of panel structure 16f and spaced longitudinally rearwardly of the cushion portion 34 of the front seating and cargo means 28. Rear seating and cargo means 30 includes a front facing cushion portion 42 and an upright seatback portion 44. Upright seatback portion 44 may have the ⅓, ⅔ split described with respect to front seating and cargo means 28 and may also have the handles and springs associated with front seating and cargo means 28. Upright seatback portion 44 is arranged by a pivot 46 to pivot forwardly and downwardly into overlying relation to seat cushion portion 42. Rear seating and cargo means 30 also includes the upper surface of rear floor structure 16f which presents a cargo surface accessible by rear gate 20a and is contiguously substantially horizontally aligned with the upper surface of the forwardly and downwardly pivoted upright seatback portion 44 so that the upper surface of rear floor structure 16f defines a smooth cargo surface with the upper face of the forwardly and downwardly folded upright seatback portion 44.

Seat cushion portions 34 and 42 are longitudinally spaced apart to allow placement of the feets of occupants of the seat cushion portions and the vehicle further includes means, including the upright seatback portions, to fill the longitudinal space between the seat cushion portions. Specifically, the upright seatback portions have a sufficient height, as measured from the pivot axes to the tops of the upright seatback portions, to fill the longitudinal space between the seat cushion portions, as seen in FIG. 7.

A mapping means for the vehicle, including a keyboard 48 positioned on left side structure 22 between forward and rearward windows 22a, 22b, may, for example, contain the information with respect to the predetermined location where the vehicle is headed.

The power means 50 for the vehicle is located below floor structure 16 and may include a battery 52 and an electric motor 54 connected to the battery by a wire 56 and a ground wire 58. Battery 52 may comprise 288 cells generating 60 kWh and comprising a nickel rich lithium battery secured to the central underface 16i of floor structure 16. Electric motor 54 may be secured to the underface 16i and may comprise a 200 hp 150 kW permanent magnet motor. The output shaft 54a of the motor is connected to a single speed transmission 60 which is secured to underface 16i and connected to universal joint 62, a driveshaft 64, a further universal joint 66, a differential 68, half shafts 70 journaled in axle housings 72 and connected to rear wheels 12b. Electric motor 54 may be regenerative in the sense that it may operate as a generator to recharge battery 52 in the event that the vehicle is in a braking mode.

Front wheels 12a may be independently suspended and braking means would be provided at each wheel 12a, 12b. The differential and wheels would normally be unsuspended by springs 74 and shackles 76 carried by axle housing 72 with the body structure, electric motor, battery, and single speed transmission comprising the sprung mass. The electric motor, transmission, and differential could be integrated which of course would vary the sprung/unsprung mass equation.

The automobile or vehicle of the invention is meant to be autonomous. As such, it will have many sensors including cameras, radar, and lidar. All of the sensors will be positioned externally of the vehicle to sense the vehicle environment. The vehicle will also include a charger adaptor for connection to battery 52. The charger adaptor can be stored in a compartment beneath panel 16f and specifically beneath a panel 16j hinged at 16k to be lifted be grip 161. The vehicle also has a further compartment beneath panel 16e and specifically beneath a panel 16m hinged at 16n to be lifted by grip 16p. This further compartment may contain cargo or may contain computer processors/software receiving input from the mapping means and the various sensors and acting to control destination, steering, braking, and acceleration.

Installing the power means below the floor structure frees up the upper face of the floor structure for the seating and cargo means. Specifically, a rear facing seat assembly can be installed proximate the front area of the vehicle, a forward facing seating assembly can be installed proximate the rear area of the vehicle, cargo surfaces forwardly of the rear facing seat assembly and rearwardly of the forward facing seat assembly can be established and a cargo surface extending from the front end of the vehicle to the rear end of the vehicle can be established by folding down the upright seatback portions of each seat assembly. Details of the power means and the body structure may, of course, vary so long as they are in accordance with the appended claims.

What I claim as my invention:

1. A land vehicle having a front end and a rear end, a floor structure having an upper surface, wheels for rollably supporting the vehicle, power means for propelling the vehicle, and a seating assembly for the vehicle, characterized in that: The floor structure is flat; the power means is positioned below the upper surface of the floor structure; and the seating assembly is positioned on the upper surface on the floor structure.

2. A land vehicle according to claim 1 wherein the power means includes a means for generating electricity and at least one electric motor.

3. A land vehicle according to claim 2 wherein the means for generating electricity comprises a battery.

4. A land vehicle according to claim 1 wherein the seating assembly includes a rearwardly facing seat assembly including a first cushion portion and a first upright seatback portion, the first upright seatback portion is pivotally mounted on the first cushion portion and moves pivotally rearwardly and downwardly into overlying relation to the first cushion portion and into substantial horizontal alignment with a first cargo surface defined by the upper face of the floor structure forwardly of the rearwardly facing seat assembly.

5. A land vehicle according to claim 4 wherein the seating assembly further includes a forwardly facing seat assembly including a second cushion portion spaced rearwardly from the first cushion portion and a second upright seatback portion pivotally mounted on the second cushion portion and movable pivotally forwardly and downwardly into overlying relation to the second cushion portion and into substantial horizontal alignment with a second cargo surface defined by the upper face of the floor structure rearwardly of the forwardly facing seat assembly.

6. A land vehicle according to claim 5 wherein the space between the seat cushion portions is filled by means, including the downwardly folded upright setback portions, the floor structure extends from the front end of the vehicle to the rear end of the vehicle, and the first and second cargo surfaces extend from the front and rear ends of the vehicle whereby to form a continuous cargo surface extending from the front end of the vehicle to the rear end of the vehicle.

7. A land vehicle according to claim 6 wherein the upright seatback portions when downwardly folded have a height sufficient to fill the space.

8. A land vehicle according to claim 6 wherein the vehicle further includes a full height front end structure attached to and extending upwardly from the front end of the floor structure and including a front gate providing front end access to the substantially continuous cargo surface, the vehicle further includes a full height rear end structure attached to and extending upwardly from the rear end of the floor structure and including a rear gate to provide rear end access to the substantially continuous cargo surface.

9. A land vehicle including wheels to support the vehicle, a floor structure extending from the front end of the vehicle to the rear end of the vehicle, power means for propelling the vehicle and seating and cargo means for the vehicle, characterized in that: the seating and cargo means includes a rearwardly facing seat assembly including a first cushion portion and a first upright seat back portion; the vehicle further includes a first cargo surface defined by the upper face of the floor structure between the front end of the vehicle and the rearwardly facing seat assembly; and the first upright seat back portion is pivotally mounted on the first cushion portion and move pivotally rearwardly and downwardly into overlying relation to the first cushion portion and into substantial horizontal alignment with the first cargo surface.

10. A land vehicle according to claim 9 wherein the seating and cargo means further includes a forwardly facing seat assembly including a second seat cushion portion spaced longitudinally rearwardly from the first seat cushion and a second upright seatback portion and further includes a second cargo surface defined by the upper face of the floor structure between the rear end of the vehicle and the forwardly facing seat assembly, the second upright seatback portion is pivotally mounted on the second cushion portion and moves pivotally forwardly and downwardly into overlying relation to the second cushion portion and into substantial horizontal alignment with the second cargo surface.

11. A land vehicle according to claim 10 wherein the longitudinal space between the cushion portions is filled by means, including the downwardly folded upright seatback portions to provide a substantially continuous cargo surface extending from the front end of the vehicle to the rear end of the vehicle.

12. A land vehicle according to claim 11 wherein the upright seatback portions when downwardly folded have a height sufficient to fill the longitudinal space.

13. A land vehicle according to claim 11 wherein the vehicle further includes a full height front end structure attached to and extending upwardly from the front end of the floor structure and including a front gate to provide front end access to the substantially continuous cargo surface.

14. A land vehicle according to claim 11 wherein the vehicle further includes a full height rear end structure attached to and extending upwardly from the rear end of the floor structure and including a rear gate to provide rear end access to the substantially continuous cargo surface.

15. A land vehicle having a front end and a rear end and including wheels to rollably support the vehicle, power means for propelling the vehicle, and a seating assembly for the vehicle, characterized in that: the seating assembly includes confronting rearwardly facing and forwardly facing seat assembles each including longitudinally spaced cushion portions and upright seatback portions, the upright seatback portion of one of the seat assemblies is mounted for movement between its upright position and a flat position overlying a cushion portion and into horizontal alignment with a horizontal cargo surface defined between the one seat assembly and an end of the vehicle.

16. A land vehicle according to claim 15 wherein the upright seatback portion of the other seat assembly is mounted for movement between its upright position and a flat position overlying a cushion portion.

17. A land vehicle according to claim 15 wherein each of the upright seatback portions is pivotally mounted relative to a cushion portion and moves rearwardly and downwardly in the rearwardly facing seat assembly to its flat position and moves forwardly and downwardly in the forwardly facing seat assembly to its flat position, the cargo surface is a first cargo surface extending to the front end of the vehicle and into which the upright seatback portion of the rearwardly facing seat assembly in its flat position moves into horizontal alignment, the vehicle further includes a second cargo surface extending to the rear end of the vehicle and into to which the upright seatback portion of the forwardly facing seat assembly it its flat position move into horizontal alignment.

18. A land vehicle according to claim 17 wherein the vehicle further includes means including the downwardly folded upright seatback portions to fill the longitudinal space between the cushion portions so as to form a substantially continuous cargo surface extending from the front end of the vehicle to the rear end of the vehicle.

19. A land vehicle according to claim 18 wherein the vehicle further includes a full height front end structure attached to and extending upwardly from the front end of the vehicle and including a gate to provide front end access to the substantially continuous cargo surface.

20. A land vehicle according to claim 8 wherein the vehicle further includes a full height rear end structure attached to and extending upwardly from the rear end of the vehicle and including a gate to provide rear end access to the substantially continuous cargo surface.

21. A land vehicle having a front end and a rear end, wheels to rollably support the vehicle, power means for propelling the vehicle, a floor structure, the upper face at the floor structure defining a first flat horizontal cargo surface and a second flat horizontal cargo surface, and a seating assembly positioned on the upper face of the floor structure between the first and second flat horizontal cargo surfaces and movable between a seating position and a flat horizontal position where it forms a third flat horizontal cargo surface which is horizontally aligned with the first and second flat horizontal cargo surfaces.

22. A land vehicle according to claim 21 wherein the flat horizontal cargo surfaces coact to define a continuous cargo surface extending from the front end of the vehicle to the rear end of the vehicle.

23. A land vehicle according to claim 21 wherein the seating assembly includes a cushion portion on the upper face of the floor structure and an upright seatback portion movable between an upright seating position and a flat horizontal position overlying the cushion portion.

24. A land vehicle according to claim 21 wherein the seating assembly comprises a rearwardly facing seat assembly, including a cushion portion and an upright seatback portion, and a confronting forwardly facing seat assembly, including a cushion portion and an upright seatback position, and the upright seatback portions are mounted for movement between an upright seating position and a flat horizontal position overlying a cushion portion.

25. A land vehicle according to claim 22 wherein the vehicle further includes a front end structure and a front gate to provide front end access to the continuous cargo surface.

26. A land vehicle according to claim 22 wherein the vehicle further includes a rear end structure and a rear gate to provide rear end access to the continuous cargo surface.

27. A land vehicle according to claim 22 wherein the vehicle further includes a side structure and a side gate to provide side access to the continuous cargo surface.

28. A land vehicle according to claim 24 wherein each upright seatback portion moves pivotally to its flat horizontal position.

29. A land vehicle according to claim 24 wherein the cushion portions are longitudinally spaced apart and the vehicle further includes means, including the upright seatback portions in their flat horizontal positions, to fill the longitudinal space between the cushion portions.

30. A land vehicle according to claim 28 wherein the upright seatback portions have a height sufficient to fill the longitudinal space between the cushion portions.
